(19) United States
(12) Patent Application Publication
(10) Pub. No.: US 2020/0213428 A1
(43) Pub. Date: Jul. 2, 2020

(54) CASING AND MOBILE PHONE HAVING THE SAME

(71) Applicant: AAC Technologies Pte. Ltd., Singapore city (SG)

(72) Inventor: Mao Liu, Shenzhen (CN)

(21) Appl. No.: 16/702,543

(22) Filed: Dec. 4, 2019

(30) Foreign Application Priority Data
Dec. 28, 2018 (CN) 201811631148.X

(51) Int. Cl. H04M 1/02; H01Q 1/24

(52) U.S. Cl. CPC H04M 1/026; H01Q 1/243

(57) ABSTRACT

The present invention provides a casing and a mobile terminal having the same. The casing includes a glass shell and an antenna element embedded in the glass shell. Therefore, the glass shell and the antenna element can form an integrated structure, achieving an integrated design of the glass shell and the antenna element.

### TECHNICAL FIELD

The present disclosure relates to the field of portable mobile terminal technologies, and more particularly, to a casing and a mobile terminal having the same.

### BACKGROUND

Conventionally, a casing of a mobile terminal (e.g., a mobile phone, a tablet computer, etc.) generally includes a glass shell and a flexible printed circuit board antenna attached to an inner surface of the glass shell.

### BRIEF DESCRIPTION OF THE DRAWINGS

FIG. 1 is an exploded view of a casing of the present disclosure before molding;

FIG. 2 is a front view of the casing of the present disclosure; and

FIG. 3 is a partial enlarged view of a portion A in FIG. 2.

### DETAILED DESCRIPTION

The present disclosure will be further described hereinafter in detail with reference to the drawings.

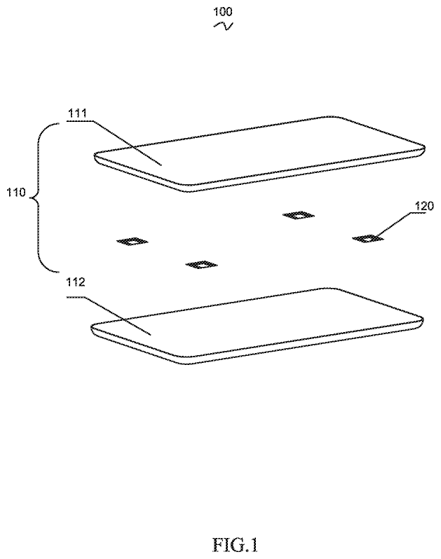

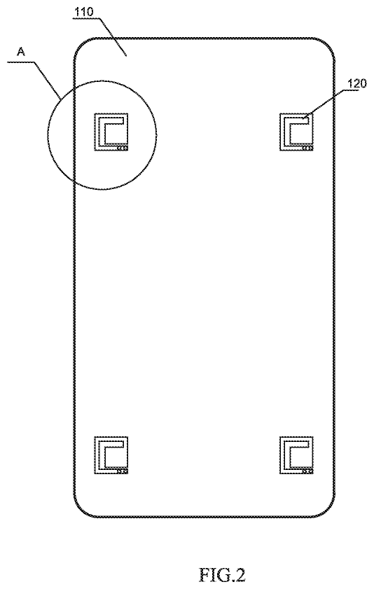

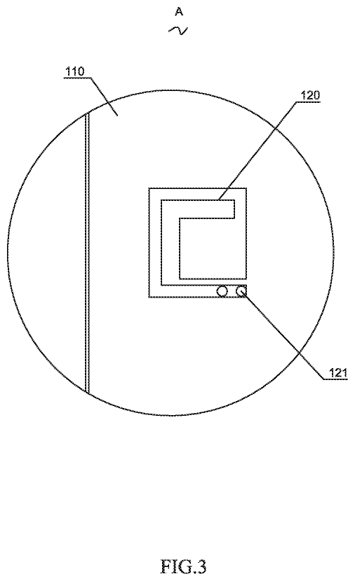

One aspect of the present disclosure relates to a casing 100 applied tin a mobile terminal. The mobile terminal can be, for example, a mobile phone, a tablet computer, etc. As shown in FIG. 1 to FIG. 3, the casing 100 includes a glass shell 110 and an antenna element 120 embedded in the glass shell 110.

The casing 100 of the present disclosure includes the glass shell 110 and the antenna element 120 embedded in the glass shell 110. Therefore, the glass shell 110 and the antenna element 120 can form an integrated structure, so that an integrated design of the glass shell 110 and the antenna element 120 is realized. Moreover, clearance may be realized utilizing the glass.

Specifically, the glass shell 110 is formed by integrally pressing a first glass shell portion 111 and a second glass shell portion 112 at a predetermined high temperature, so that the antenna element 120 arranged between the first glass shell portion 111 and the second glass shell portion 112 is embedded in the glass shell 110. The antenna element 120 represents flaky shape or has a mesh structure, that is, the antenna element 120 can be a metal foil or a metal mesh etc., and is preferably a copper foil or a copper mesh.

It should be noted that a total thickness of the casing 100 is not limited. For example, a thickness of the first glass shell portion 111 can range from 0.2 mm to 0.4 mm, and a thickness of the second glass shell portion 112 can range from 0.2 mm to 0.4 mm. Of course, the thicknesses of the first glass shell portion 111 and the thicknesses of the second glass shell portion 112 may also be selected from other numerical ranges.

At least two antenna elements 120 are provided, and the at least two antenna elements 120 form a MIMO (Multiple-Input Multiple-Output) antenna system. In the embodiment, four antenna elements 120 are provided, which are respectively disposed at corner portions of the casing 100. Of course, more antenna units 120 can also be provided according to actual needs, and a location of each antenna element can be determined according to actual needs.

The glass shell 110 has a contact 121 for feeding the antenna element 120 configured thereon. The contact 121 is arranged inside the glass shell 110.

In another aspect of the present disclosure, a mobile terminal (such as a mobile phone, a tablet computer, etc.) including the casing 100 described above is provided.

The description above is merely embodiments of the present disclosure, and it should be pointed out that, those of ordinary skills in the art can make improvements without departing from the inventive concept of the present disclosure, but these all belong to the scope of protection of the present disclosure.

What is claimed is:

1. A casing, comprising a glass shell and an antenna element embedded in the glass shell.

2. The casing according to claim 1, wherein the glass shell is formed by integrally pressing a first glass shell portion and a second glass shell portion at a predetermined temperature, thereby embedding the antenna element arranged between the first glass shell portion and the second glass shell portion in the glass shell.

3. The casing according to claim 1, Wherein the antenna element represents flaky shape or has a mesh structure.

4. The casing according to claim 1, wherein at least two antenna elements are provided, and the at least two antenna elements form a MIMO antenna system.

5. The casing according to claim 4, Wherein four antenna elements are provided, and the four antenna elements are respectively disposed at corner portions of the casing.

6. The casing according to claim 1, wherein a contact for feeding the antenna element is configured on the glass shell.

7. A mobile terminal, comprising a glass shell and an antenna element embedded in the glass shell.

8. The mobile terminal according to claim 7, wherein the glass shell is formed by integrally pressing a first glass shell portion and a second glass shell portion at a predetermined temperature, thereby embedding the antenna element arranged between the first glass shell portion and the second glass shell portion in the glass shell.

9. The mobile terminal according to claim 7, wherein the antenna element represents flaky shape or has a mesh structure.

10. The mobile terminal according to claim 7, wherein at least two antenna elements are provided, and the at least two antenna elements form a MIMO antenna system.

11. The mobile terminal according to claim 10, wherein four antenna elements are provided, and the four antenna elements are respectively disposed at corner portions of the casing.

12. The mobile terminal according to claim 7, wherein a contact for feeding the antenna element is configured on the glass shell.
